(19) United States
(12) Patent Application Publication
(10) Pub. No.: US 2026/0095770 A1
(43) Pub. Date: Apr. 2, 2026

(54) USER EQUIPMENT RADIO RESOURCE CONTROL INACTIVE STATE HANDLING IN A RADIO ACCESS NETWORK (RAN) DISAGGREGATED ARCHITECTURE

(71) Applicant: Nokia Technologies Oy, Espoo (FI)

(72) Inventors: Amaanat ALI, Espoo (FI); Daniela LASELVA, Aalborg (DK); Tero HENTTONEN, Espoo (FI); Janne Veikko KAASALAINEN, Espoo (FI)

(21) Appl. No.: 19/110,633

(22) PCT Filed: Sep. 13, 2022
(86) PCT No.: PCT/EP2022/075420

§ 371 Date: Mar. 11, 2025

(51) Int. Cl. H04W 12/106; H04W 12/041

(52) U.S. Cl. CPC H04W 12/106; H04W 12/041

(57) ABSTRACT

In accordance with example embodiments of the invention there is at least a method and an apparatus to perform determining based upon being released to an radio resource control inactive state information comprising at least one of a first integrity key generated by a centralized unit associated with a communication network or a second integrity key generated by a first distributed unit associated with the communication network; and selecting between using the first integrity key or the second integrity key based on at least one of a radio resource control message or a radio resource control state. Further, to perform determining for integrity protection of radio resource control messages an information context of a user equipment, comprising a first integrity key and a second integrity key associated with the apparatus, and selecting between using the first integrity key or the second integrity keys based on the radio resource control message.

### TECHNICAL FIELD

The teachings in accordance with the exemplary embodiments of this invention relate generally to a user equipment radio resource control inactive state handling in a radio access network (RAN) disaggregated architecture, and more specifically relates to a user equipment radio resource control deriving and utilizing an additional integrity key for inactive state handling in the RAN disaggregated architecture where the radio resource control protocol (RRC) layer is split.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
CU centralized unit
CP control Plane
C-RNTI connected mode Radio network temporary identifier
DU distributed unit
Enc encryption
NR new Radio
gNB 5G Node B
int integrity
I-RNTI inactive radio network temporary identifier
MAC-I message authentication code—integrity
NCC next hop chaining count
NG-RAN next generation—Radio Access Network
NR new radio
RAN radio access network
RNA radio access network notification area
RNAU radio access network notification area Update
RRC radio resource control protocol
UE user equipment
UP user plane
XnXn network interface

In New Radio (NR), in the centralized unit/distributed unit (CU/DU) architecture split, the radio resource control (RRC) protocol is terminated in the CU, which handles the bearer termination aspects including the security at NR PDCP layer (i.e. the CU prepares the final and secured RRC message towards the UE). However, the DU is in charge of the lower layers (i.e. provides the radio configuration parameters to the CU). In recent internal 6G discussions, a few architecture options related to different splitting of the RRC functionalities between CU and DU have been on the table especially in the light of addressing some identified issues of the CU/DU architecture split for 6G systems.

One such architecture option wherein the proposal is to for the CU to continue to handle the radio bearer configuration (i.e., RB configuration) aspects but the RRC remains fully terminated in the DU (as opposed to the CU in NR). In this option, the understanding is that the DU formats the final RRC message to the UE, i.e. it hosts the NR PDCP layer for the RRC SRB(s) and it also terminates radio level security for the control plane (i.e. RRC SRB(s)).

Furthermore, this option proposes to have a network centric RRC-i entity (RRC-internal), which is invisible to the user equipment (UE) but prepares and handles the radio bearer configuration (i.e. RB configuration) for the PDU sessions and uses the DU to provide an encapsulation layer to transport signalling messages back and forth between the CU and UE.

Example embodiments of the invention work to improve at least these operations.

### SUMMARY

This section contains examples of possible implementations and is not meant to be limiting.

In an example aspect of the invention, there is an apparatus, such as a user equipment side apparatus, comprising: at least one processor; and at least one memory including computer program code, where the at least one memory and the computer program code are configured, with the at least one processor, to cause the apparatus to at least: determine at least one of a first integrity key associated with a communication network or a second integrity key associated with the communication network and select between using the first integrity key or the second integrity key based on at least one of a radio resource control message or a radio resource control state.

In another example aspect of the invention, there is a method comprising: determining at least one of a first integrity key associated with the apparatus or a second integrity key associated with the apparatus, and selecting between using the first integrity key or the second integrity keys based on the radio resource control message and selecting between using the first integrity key or the second integrity key based on at least one of a radio resource control message or a radio resource control state.

A further example embodiment is an apparatus and a method comprising the apparatus and the method of the previous paragraphs, wherein there is selecting the second integrity key for at least a radio resource control resume request message, and use the selected integrity key to generate an integrity token for at least the radio resource control resume request message, wherein there is selecting the second integrity key for at least a radio resource control release message, and use the selected integrity key to generate an integrity token to verify the integrity token validity of the radio resource control release message received from the network, wherein the determined at least one of the first integrity key or the second integrity key is based upon being released out of a connected state, wherein the at least one of a first integrity key is generated by a centralized unit associated with the communication network or a second integrity key is generated by a first distributed unit associated with the communication network, wherein the first integrity key and the second integrity key are determined, by a first distributed unit and centralized unit associated with the apparatus, one of before or after identifying that a radio resource control configuration with the user equipment is to be released and the user equipment is to be dispatched to a radio resource control inactive state, wherein the at least one of a first integrity key or a second integrity key is generated by at least one of a first distributed unit or a centralized unit associated with the communication network, wherein generating the second integrity key is based on keying material received from the network, wherein the keying material is received upon the UE is dispatched to a radio resource control inactive state, wherein the keying material is received together with a user equipment identifier to be used in the radio resource control inactive state, wherein the at least the first integrity key and the second integrity key is one of predetermined by the user equipment or derived by the user equipment, wherein the keying material comprises at least one of an indication of an integrity protection algorithm and an indication of an algorithm identifier, wherein the integrity token comprises a resumeMAC-I, wherein the first integrity key is the K_{RRCint} key, and UE using the first integrity key to apply integrity protection for all radio resource control messages but radio resource control resume request message, wherein the selected integrity key comprises the second integrity key, wherein the keying material comprises an integrity protection algorithm and algorithm identifier which can be fed in to a key derivation algorithm by the user equipment to generate the integrity token for the radio resource control resume request message by the user equipment, wherein the information context comprises a security context including a KRRCint_resume key for the user equipment, wherein the KRRCint_resume key is used to verify the resumeMAC-I validity as the user equipment performs a radio resource control resume procedure, wherein there is storing the information comprising the at least one of a first integrity key or a second integrity key, wherein there is store the information comprising the at least one of a first integrity key or a second integrity key, wherein the storing is based on a validity timer, wherein at expiration of the validity timer the information context is discarded, wherein the validity timer is configured by the first distributed unit as a T_INACTIVE_DU, wherein there is using the selected integrity key to generate an integrity token for at least a radio resource control resume request message, and wherein there is using the selected integrity key to validate an integrity token for at least a radio resource control resume request message received from the user equipment, and/or wherein the user equipment has not yet determined it has moved to an area of a communication network controlled by the apparatus.

A non-transitory computer-readable medium storing program code, the program code executed by at least one processor to perform at least the method as described in the paragraphs above.

In another example aspect of the invention, there is an apparatus comprising: means for determining at least one of a first integrity key associated with a communication network or a second integrity key associated with the communication network and means for selecting between using the first integrity key or the second integrity key based on at least one of a radio resource control message or a radio resource control state.

In accordance with the example embodiments as described in the paragraph above, at least the means for storing, selecting, and using comprises a network interface, and computer program code stored on a computer-readable medium and executed by at least one processor.

In another example aspect of the invention, there is an apparatus, such as a network side apparatus, comprising: at least one processor; and at least one memory including computer program code, where the at least one memory and the computer program code are configured, with the at least one processor, to cause the apparatus to at least: generate and store, by a network node of a communication network, an information context for a user equipment at least a first integrity key and a second integrity key for integrity protection of radio resource control messages of the user equipment, and select between using the first integrity key or the second integrity keys based on the radio resource control message, and use the selected integrity key to validate an integrity token for at least a radio resource control resume request message received from the user equipment.

In still another example aspect of the invention, there is a method, comprising: storing for integrity protection of radio resource control messages an information context of a user equipment, comprising a first integrity key and a second integrity key associated with the apparatus, and selecting between using the first integrity key or the second integrity keys based on the radio resource control message and selecting between using the first integrity key or the second integrity keys based on the radio resource control message.

A further example embodiment is an apparatus and a method comprising the apparatus and the method of the previous paragraphs,, wherein the first integrity key and the second integrity key are determined, by a first distributed unit and centralized unit associated with the apparatus, one of before or after identifying that a radio resource control configuration with the user equipment is to be released and the user equipment is to be dispatched to a radio resource control inactive state, wherein the at least one of a first integrity key or a second integrity key is generated by at least one of a first distributed unit or a centralized unit associated with the communication network, wherein generating the second integrity key is based on keying material received from the network, wherein the keying material is received upon the UE is dispatched to a radio resource control inactive state, wherein the keying material is received together with a user equipment identifier to be used in a radio resource control inactive state, wherein the at least the first integrity key and the second integrity key is one of predetermined by the user equipment or derived by the user equipment, wherein the keying material comprises at least one of an indication of an integrity protection algorithm and an indication of an algorithm identifier, wherein the integrity token comprises a resumeMAC-I, wherein the first integrity key is the K_{RRCint} key, and UE using the first integrity key to apply integrity protection for all radio resource control messages but radio resource control resume request message, wherein the selected integrity key comprises the second integrity key, wherein the keying material comprises an integrity protection algorithm and algorithm identifier which can be fed in to a key derivation algorithm by the user equipment to generate the integrity token for the radio resource control resume request message by the user equipment, wherein the information context comprises a security context including a KRRCint_resume key for the user equipment, wherein the KRRCint_resume key is used to verify the resumeMAC-I validity as the user equipment performs a radio resource control resume procedure, wherein there is storing the information comprising the at least one of a first integrity key or a second integrity key, wherein there is store the information comprising the at least one of a first integrity key or a second integrity key, wherein the storing is based on a validity timer, wherein at expiration of the validity timer the information context is discarded, wherein the validity timer is configured by the first distributed unit as a T_INACTIVE_DU, wherein the user equipment has not yet determined it has moved to an area of a communication network controlled by the apparatus, wherein there is receiving from the user equipment, by a second distributed unit of the apparatus, a user equipment context retrieve request and a radio resource control resume request, wherein the radio resource control resume request comprises the resumeMAC-I and an indication of the integrity token, wherein based on the second distributed unit not identifying the user equipment, wherein there is sending towards the centralized unit the radio resource control resume request including a resumeMAC-I, wherein based on the second distributed unit identifying the user equipment, there is sending the received resumeMAC-I using the stored key received from the centralized unit, wherein there is delivering with the centralized unit the information context to the second distributed unit in response to the requests from the user equipment, wherein there is using the selected integrity key to validate an integrity token for at least a radio resource control resume request message received from the user equipment, wherein the at least one of a first integrity key or a second integrity key is generated by at least one of a first distributed unit or a centralized unit associated with the communication network, and/or wherein the first integrity key and the second integrity key are determined, by a first distributed unit and centralized unit associated with the apparatus, one of before or after identifying that a radio resource control configuration with the user equipment is to be released and the user equipment is to be dispatched to a radio resource control inactive state.

A non-transitory computer-readable medium storing program code, the program code executed by at least one processor to perform at least the method as described in the paragraphs above.

In another example aspect of the invention, there is an apparatus comprising: means for storing for integrity protection of radio resource control messages an information context of a user equipment, comprising a first integrity key and a second integrity key associated with the apparatus, and selecting between using the first integrity key or the second integrity keys based on the radio resource control message, and means for selecting between using the first integrity key or the second integrity keys based on the radio resource control message.

In accordance with the example embodiments as described in the paragraph above, at least the means for storing, selecting, and using comprises a network interface, and computer program code stored on a computer-readable medium and executed by at least one processor.

A communication system comprising the network side apparatus and the user equipment side apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows an RRC architectural split option proposed for 6G;

FIG. 2A shows an RRCResumeRequest1 message; and

FIG. 2B shows a UE Context retrieve for inter-gNB resume as defined in Section 9.2.1.13 UE Context Information—Retrieve UE Context Response of TS 38.423;

FIG. 3 shows a key hierarchy generation in 5GS showing the new key derivation (i.e. KRRCint_resume);

FIG. 4 shows an implementation of a proposed method in accordance with example embodiments of the invention;

FIG. 5 shows a high level block diagram of various devices used in carrying out various aspects of the invention; and

FIG. 6A and FIG. 6B each show a method in accordance with example embodiments of the invention which may be performed by an apparatus.

### DETAILED DESCRIPTION

In example embodiments of this invention there is proposed at least a method and apparatus to enable user equipment radio resource control deriving and utilizing an additional integrity key for inactive state handling in an architecture such as a radio access network (RAN) disaggregated architecture.

As similarly stated above, In New Radio (NR), in the centralized unit/distributed unit (CU/DU) architecture split, the radio resource control (RRC) protocol is terminated in the CU, which handles the bearer termination aspects including the security at NR PDCP layer (i.e. the CU prepares the final and secured RRC message towards the UE). However, the DU is in charge of the lower layers (i.e. provides the radio configuration parameters to the CU). In recent internal 6G discussions, a few architecture options related to different splitting of the RRC functionalities between CU and DU have been on the table especially in the light of addressing some identified issues of the CU/DU architecture split for 6G systems.

One such architecture option wherein the proposal is to for the CU to continue to handle the radio bearer configuration (i.e. RB configuration) aspects but the RRC remains fully terminated in the DU (as opposed to the CU in NR). In this option, the understanding is that the DU formats the final RRC message to the UE, i.e. it hosts the NR PDCP layer for the RRC SRB(s) and it also terminates radio level security for the control plane (i.e. RRC SRB(s)).

Furthermore, this option proposes to have a network centric RRC-i entity (RRC-internal), which is invisible to the UE but prepares and handles the radio bearer configuration (i.e. RB configuration) for the PDU sessions and uses the DU to provide an encapsulation layer to transport signalling messages back and forth between the CU and UE. Of course, the RRC protocol at the UE side is not affected by this RRC-i (avoiding the complicated discussions during standardization phase of how to split and specify RRC messages and procedures in RRC specifications with dual signalling architecture assumptions proposed e.g., in the alternative A3 option where the network and UE state RRC comprises of dual RRC concept (RRC-H and RRC-L).

RRC INACTIVE is a feature in NR RRC wherein the UE enters into a suspended RRC state which primarily is guided by power saving motivations due to user plane inactivity. The RRC INACTIVE requires that the network provides an identifier called the I-RNTI, which helps identify the UE in a given PLMN unambiguously. During the resume phase, the UE formats a RRC Resume Request message in the uplink with the assigned I-RNTI and appends a resumeMAC-I (i.e. integrity token).

RRC inactive mode is more or less same as an RRC idle mode with the exception that UE will store the RRC context for some time. After some timer expiry, UE will just delete that context and move to RRC idle mode. According to standards at the time of this application in response to a request to resume the RRC connection, the network may resume the suspended RRC connection and send UE to RRC_CONNECTED, or reject the request to resume and send UE to RRC_INACTIVE (with a wait timer), or directly re-suspend the RRC connection and send UE to RRC_INACTIVE, or directly release the RRC connection and send UE to RRC_IDLE, or instruct the UE to initiate NAS level recovery (in this case the network sends an RRC setup message).

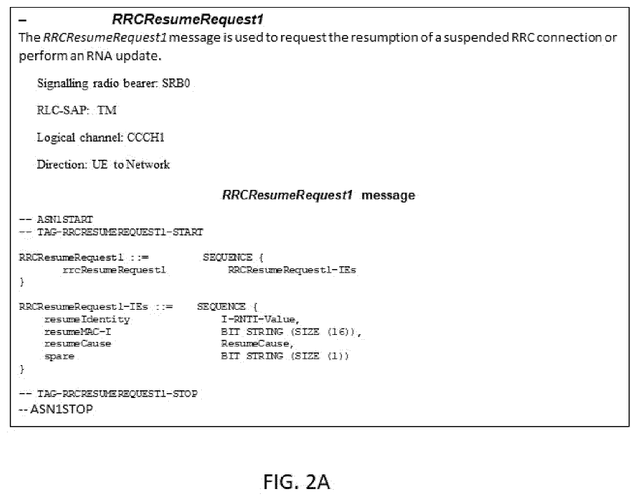

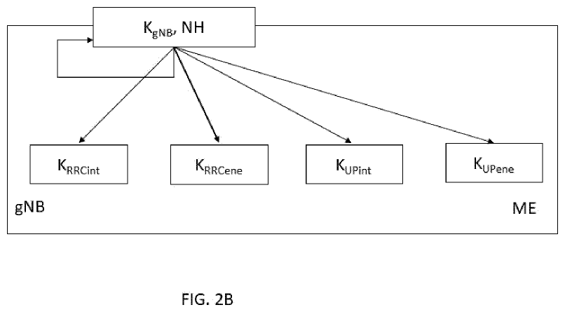

FIG. 2A shows an RRCResumeRequest1 message. It is noted that in the message there is a RRCResumeRequest1-IEs sequence with a resumeIdentity I-RNTI-Value, and a resumeM-I with a bit string size (16).

### This Includes:

1>set the resumeMAC-I to the 16 least significant bits of the MAC-I calculated:
   2>over the ASN.1 encoded as per clause 8 (i.e., a multiple of 8 bits) VarResumeMAC-Input;
   2>with the K_{RRCint} key in the UE Inactive AS Context and the previously configured integrity protection algorithm; and
      2>with all input bits for COUNT, BEARER and DIRECTION set to binary ones.

In NR RRC with CU/DU split architecture, the resume identity is allocated by the CU. The resumeMAC-I is computed by the UE using the following: {VarResumeMAC-Input; K_{RRCint}}:
In NR RRC, the K_{RRCint} is generated at the cu (as it terminates the NR PDCP for the RRC SRB(s));
In NR RRC, the VarResumeMAC-Input; is based on a combination of the following {source cell PCI, source cell C-RNTI, target cell identity read off from broadcast on the SIB1 in the cell where the UE resumes}.

In standards at the time of this application, the handling of the security keys at gNB and UE at the RRC state transitions to RRC Connected from RRC Inactive is described. Key excerpts/summary aspects are provided below:
When the UE attempts resuming, the RRCResumeRequest message shall include the I-RNTI for context identification and a ResumeMAC-I/shortResumeMAC-I. The latter is a 16-bit message authentication token that the UE shall calculate using the integrity algorithm (NIA or EIA) in the stored AS security context, which was negotiated between the UE and the source gNB or ng-eNB, and the current K_{RRCint} with certain known inputs:
   Key: it Shall Be Set to Current K_{RRCint};
   BEARER: all its bits shall be set to 1;
   DIRECTION: its bit shall be set to 1;
   COUNT: all its bits shall be set to 1;
   MESSAGE: it shall be set to VarResumeMAC-Input/VarShortInactiveMAC-Input as defined in TS 38.331 [22] for gNB and in TS 36.331 [69] for ng-eNB with following inputs:
      source PCI, target Cell-ID, source C-RNTI.

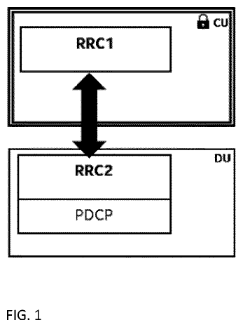

In example embodiments of this invention, it is assumed that architecture option as described is adopted in 6G (as shown in FIG. 1). In the context of this invention, it is worth noting that in this option, in accordance with example embodiments of the invention the NR PDCP for the RRC SRB(s) can be terminated in the DU, which means that the AS security is processed in the DU.

The UE in RRC inactive state can attempt to resume the RRC connection in the last serving DU (denoted here intra-DU resume) or through a different DU or even different CU (denoted here inter-DU and inter-CU resume). As spelt in the background section, the RRC INACTIVE resumption of a UE works smoothly in the inter-DU/CU resume under the assumption that the RRC layer is terminated in the CU (i.e. the CU has all the security material to process and validate the resumeMAC-I received from the UE at resume).

With RRC architecture alternative, with AS security terminated in the DU, it is impossible for the CU to verify the resumeMAC-I all by itself in the scenarios mentioned above in which the UE resumes in a DU different from last serving DU (i.e. the one the UE was dispatched to RRC INACTIVE). The alternative for the CU here is to contact the last serving DU (called also source DU in the following) and request the MAC-I verification (and possibly to fetch the UE context stored at the DU).

The overall cost of this is 4 F1 messages:
target DU forwards RRC resume request to CU (1 message);
CU contacts source DU to authenticate the UE (1 message, 1 message);
CU contacts target DU with the result of the authentication (1 message)
   Assuming a modest delay of 5 msec for one-way F1 message, the delay in inactive state resumption would be increased by 20 msec due to such procedure, which is undesired.

The key hierarchy generation in 5GS as defined in TS 33.501, allowing derivation of the AS keys (i.e. KgNB, KRRCint, KRRCenc, KUPint and KUPenc). Such derivation is used in this invention

FIG. 2B shows a UE Context retrieve for inter-gNB resume as defined in Section 9.2.1.13 UE Context Information—Retrieve UE Context Response of TS 38.423.

UE Context retrieve for inter-gNB resume is defined in Section 9.2.1.13 UE Context Information—Retrieve UE Context Response of TS 38.423.

This invention proposes a method for the CU, in an architecture option as described herein, to derive and utilize an additional integrity key for integrity protection, enabling the CU to verify the resumeMAC-I received from the UE during the RRC resume procedure (initiated by the UE through a cell of a different DU than its last serving DU). Such key is denoted K_{RRCint_resume} and is used by the network in addition to the existing K_{RRCint}, which is used by the DU for integrity protection of the RRC messages in this architecture option. Likewise, the UE has to derive and use the same key when generating the resumeMAC-I.

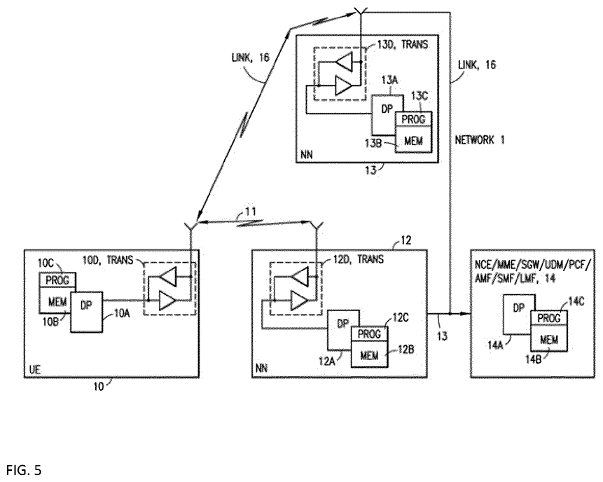

Before describing the example embodiments of the invention in detail, reference is made to FIG. 5 for illustrating a simplified block diagram of various electronic devices that are suitable for use in practicing the example embodiments of this invention.

FIG. 5 shows a block diagram of one possible and non-limiting exemplary system in which the example embodiments of the invention may be practiced. In FIG. 5, a user equipment (UE) 10 is in wireless communication with a wireless network 1 or network, 1 as in FIG. 5. The wireless network 1 or network 1 as in FIG. 5 can comprise a communication network such as a mobile network e.g., the mobile network 1 or first mobile network as disclosed herein. Any reference herein to a wireless network 1 as in FIG. 5 can be seen as a reference to any wireless network as disclosed herein. Further, the wireless network 1 as in FIG. 5 can also comprises hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded or vehicle-mounted mobile device and performs a language signaling and/or data exchange with the RAN.

The UE 10 includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to NN 12 and NN 13, respectively. The one or more memories MEM 10B include computer program code PROG 10C. The UE 10 communicates with NN 12 and/or NN 13 via a wireless link 11 or 16.

The NN 12 (NR/5G Node B, an evolved NB, or LTE device) is a network node such as a master or secondary node base station (e.g., for NR or LTE long term evolution) that communicates with devices such as NN 13 and UE 10 of FIG. 5. The NN 12 provides access to wireless devices such as the UE 10 to the wireless network 1. The NN 12 includes one or more processors DP 12A, one or more memories MEM 12B, and one or more transceivers TRANS 12D interconnected through one or more buses. In accordance with the example embodiments these TRANS 12D can include X2 and/or Xn interfaces for use to perform the example embodiments of the invention. Each of the one or more transceivers TRANS 12D includes a receiver and a transmitter. The one or more transceivers TRANS 12D can be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the NN 13 such as via link 16. Further, the link 11, link 16 and/or any other link may be wired or wireless or both and may implement, e.g., an X2 or Xn interface. Further the link 11 and/or link 16 may be through other network devices such as, but not limited to an NCE/MME/SGW/UDM/PCF/AMF/SMF/LMF 14 device as in FIG. 5. The NN 12 may perform functionalities of an MME (Mobility Management Entity) or SGW (Serving Gateway), such as a User Plane Functionality, and/or an Access Management functionality for LTE and similar functionality for 5G.

The NN 13 can be associated with a mobility function device such as an AMF or SMF, further the NN 13 may comprise a NR/5G Node B or possibly an evolved NB a base station such as a master or secondary node base station (e.g., for NR or LTE long term evolution) that communicates with devices such as the NN 12 and/or UE 10 and/or the wireless network 1. The NN 13 includes one or more processors DP 13A, one or more memories MEM 13B, one or more network interfaces, and one or more transceivers TRANS 13D interconnected through one or more buses. In accordance with the example embodiments these network interfaces of NN 13 can include X2 and/or Xn interfaces for use to perform the example embodiments of the invention. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the NN 13 to perform one or more of the operations as described herein. The NN 13 may communicate with another mobility function device and/or eNB such as the NN 12 and the UE 10 or any other device using, e.g., link 11 or link 16 or another link. The Link 16 as shown in FIG. 5 can be used for communication between the NN12 and the NN13. These links maybe wired or wireless or both and may implement, e.g., an X2 or Xn interface. Further, as stated above the link 11 and/or link 16 may be through other network devices such as, but not limited to an NCE/MME/SGW device such as the NCE/MME/SGW/UDM/PCF/AMF/SMF/LMF 14 of FIG. 5.

The one or more buses of the device of FIG. 5 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and these devices can include one or more buses that could be implemented in part as fiber optic cable to connect the other elements of the NN 12 to a RRH.

It is noted that although FIG. 5 shows a network nodes such as NN 12 and NN 13, any of these nodes may can incorporate or be incorporated into an eNodeB or eNB or gNB such as for LTE and NR, and would still be configurable to perform example embodiments of the invention.

Also it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB.

The wireless network 1 or any network it can represent may or may not include a NCE/MME/SGW/UDM/PCF/AMF/SMF/LMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management Function (AMF) functionality, and/or Session Management (SMF) functionality, and/or Location Management Function (LMF), and/or Authentication Server (AUSF) functionality and which provides connectivity with a further network, such as a telephone network and/or a data communications network (e.g., the Internet), and which is configured to perform any 5G and/or NR operations in addition to or instead of other standard operations at the time of this application. The NCE/MME/SGW/UDM/PCF/AMF/SMF/LMF 14 is configurable to perform operations in accordance with example embodiments of the invention in any of an LTE, NR, 5G and/or any standards based communication technologies being performed or discussed at the time of this application. In addition, it is noted that the operations in accordance with example embodiments of the invention, as performed by the NN 12 and/or NN 13, may also be performed at the NCE/MME/SGW/UDM/PCF/AMF/SMF/LMF 14.

The NCE/MME/SGW/UDM/PCF/AMF/SMF/LMF 14 includes one or more processors DP 14A, one or more memories MEM 14B, and one or more network interfaces (N/W I/F(s)), interconnected through one or more buses coupled with the link 13 and/or link 16. In accordance with the example embodiments these network interfaces can include X2 and/or Xn interfaces for use to perform the example embodiments of the invention. The one or more memories MEM 14B include computer program code PROG 14C. The one or more memories MEM14B and the computer program code PROG 14C are configured to, with the one or more processors DP 14A, cause the NCE/MME/SGW/UDM/PCF/AMF/SMF/LMF 14 to perform one or more operations which may be needed to support the operations in accordance with the example embodiments of the invention.

It is noted that that the NN 12 and/or NN 13 and/or UE 10 can be configured (e.g., based on standards implementations etc.) to perform functionality of a Location Management Function (LMF). The LMF functionality may be embodied in any of these network devices or other devices associated with these devices. In addition, an LMF such as the LMF of the MME/SGW/UDM/PCF/AMF/SMF/LMF 14 of FIG. 5, as at least described below, can be co-located with UE 10 such as to be separate from the NN 12 and/or NN 13 of FIG. 5 for performing operations in accordance with example embodiments of the invention as disclosed herein.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, and/or DP14A and memories MEM 10B, MEM 12B, MEM 13B, and/or MEM 14B, and also such virtualized entities create technical effects.

The computer readable memories MEM 12B, MEM 13B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, and MEM 14B may be means for performing storage functions. The processors DP10, DP12A, DP13A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, and DP14A may be means for performing functions, such as controlling the UE 10, NN 12, NN 13, and other functions as described herein.

In general, various embodiments of any of these devices can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Further, the various embodiments of any of these devices can be used with a UE vehicle, a High Altitude Platform Station, or any other such type node associated with a terrestrial network or any drone type radio or a radio in aircraft or other airborne vehicle.

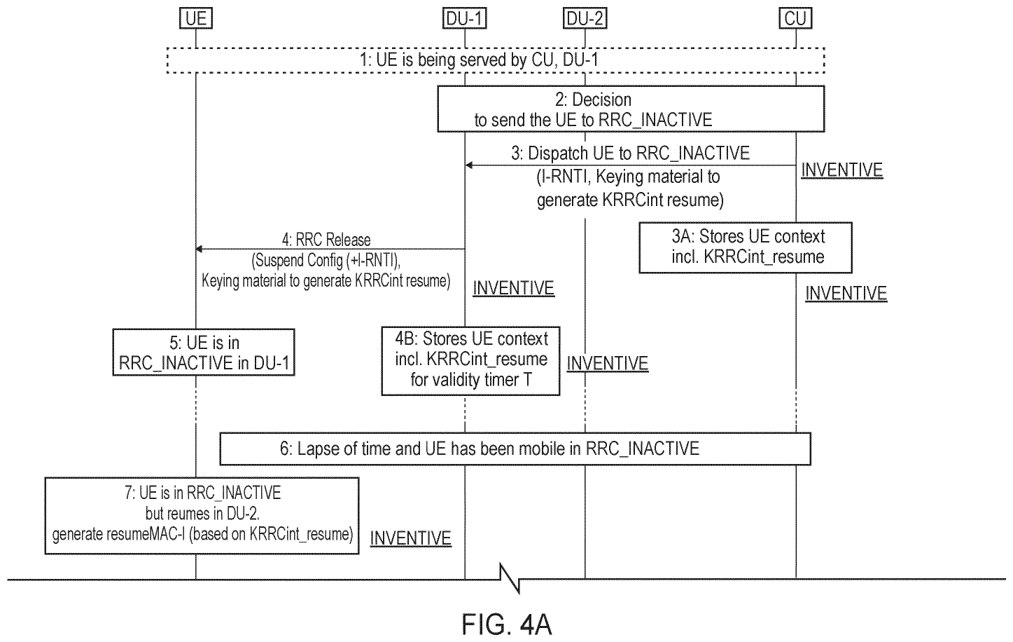

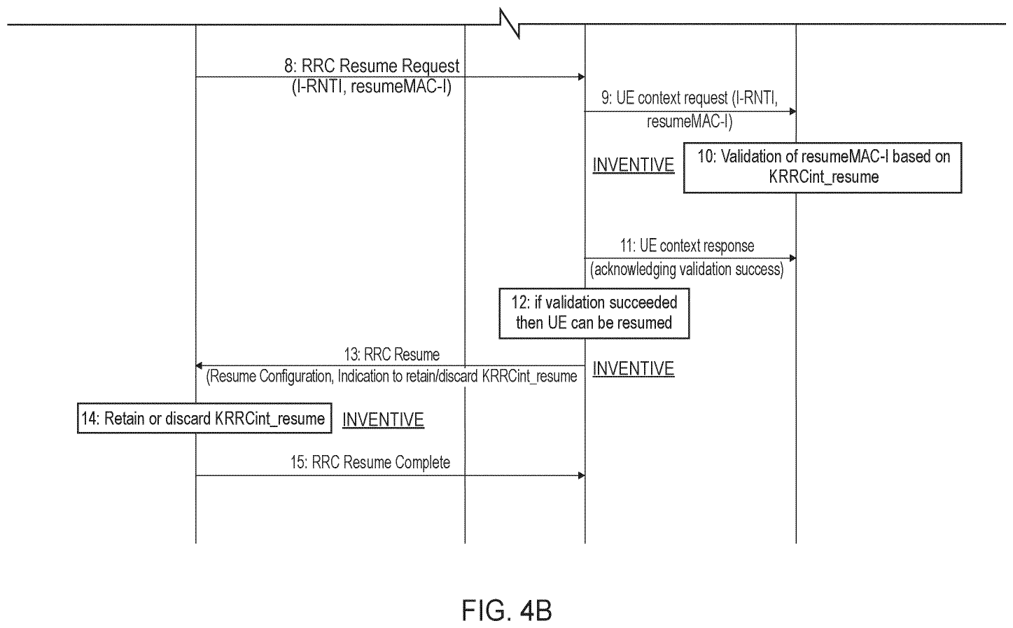

FIG. 4 shown an implementation of a proposed method in accordance with example embodiments of the invention.

The implementation comprises of the following steps as shown in FIG. 4:
Step 1: UE is in the area controlled by DU-1 (UE doesn't know about it but this is important to state as the invention comprises of network parts as well);
Step 2: Network decides to put UE to RRC_INACTIVE state;
Step 3: CU assigns I-RNTI and also provides the keying material (e.g., integrity protection algorithm and algorithm ID which can be fed in to a key derivation algorithm by the UE and derive the KRRCint_resume), and sends it to DU-1 to send it to the UE;
Step 3A: CU stores the UE context (incl. I-RNTI, radio capabilities, security context, incl. the KRRCint_resume key;
Step 4-5: The UE receives and stores the information, and moves to RRC_INACTIVE:
   Step 4B: Optional embodiment: DU-1 can also store the UE context and KRRCint_resume key to be ready to locally verify the resumeMAC-I if the UE returns and resume via the last serving DU (DU-1). Such storing can be temporary based on a validity timer, after which the context may be discarded. This can be controlled by an associate timer configured to DU (e.g., T_INACTIVE_DU, e.g., 10 sec or 2 min):
      This step is attractive for returning UEs, who are semi-stationary, and who can initiate multiple resumes/small data transmission procedures in the last serving DU;
Step 6: Assume UE is mobile and moves out of the coverage area of DU-1 (again UE is not aware of DU-1 or DU-2 but this is just illustrated to show the network side aspects that are relevant in this invention);
Step 7: Upon a trigger to resume the connection (e.g., presence of data or signalling in the UE buffer), the UE initiates the resume procedure. UE generates the resumeMAC-I based on K_{RRCint_resume};
Step 8: UE sends the RRCResumeRequest to DU-2 via a cell of DU-2, including the resumeMAC-I;
Step 9: DU-2 cannot identify the UE, and thus sends the UE context retrieve request along with the RRCResumeRequest received by the UE to the CU, including the resumeMAC-I; and
Step 10: CU can identify the UE based on the I-RNTI, and validates the received resumeMAC-I, the identifying is to be used in inactive and/or idle state; Then CU can deliver the UE context to the DU-2 in response to the request if the MAC-I verification was successful.

It is noted that inventive parts of FIG. 4 are marked “Inventive.” These inventive parts include in step 3 of FIG. 4 the CU dispatching UE to RRC_INACTIVE (I-RNTI, Keying Material to generate K_{RRCint_resume}, as shown in step 3A of FIG. 4 the CU stores UE context including the K_{RRCint_resume}, as shown in step 4 of FIG. 4 the DU-1 sends towards the UE keying material to generate K_{RRCint_resume}, as shown in FIG. 4B of FIG. 4 the DU-1 stores the UE context including the K_{RRCint_resume} for validity Timer T, as shown in step 7 of FIG. 4 the UE is generating resumeMAC-I based on K_{RRCint_resume}, as shown in step 10 of FIG. 4 the CU performs validation of resumeMAC-I based on K_{RRCint_resume}, as shown in step 13 of FIG. 4 the DU-2 sends towards the UE an indication to discard K_{RRCint_resume}, and as shown in step 14 of FIG. 4 the UE retains or discards K_{RRCint_resume}.

### Additional Embodiments

Additionally or alternatively, the UE can be provided with an area within which UE can use either of the integrity protection keys when generating the resumeMAC-I (K_{RRC_int} or K_{RRCint_resume}):
Such area can be defined as the RNA, and may contain all the cells belonging to last serving DU (DU-1);
In one example, such area is provided in step 4 above;
In such case, the DU-1 receiving the ResumeMAC-I from the UE, can verify whether the resumeMAC-I validation is successful using either key as it stores both K_{RRCint} and K_{RRCint_resume}; and
In one option, the UE has to use K_{RRC_int} within the configured area and K_{RRCint_resume} outside the configured area.

The UE and DU derive and apply the existing K_{RRC_int} to perform integrity protection to RRC messages that require it (i.e. the UE/DU computes the MAC-I based on K_{RRC_int} to be included in the PDCP PDU encapsulating the RRC messages for the purpose of integrity protection).

In one option, the UE has to use K_{RRCint_resume} within the configured area when applying integrity protection of RRC messages.

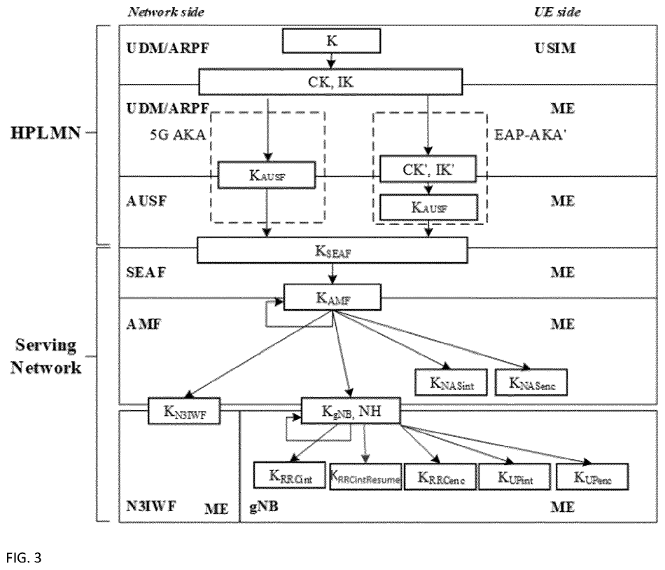

It is noted that as shown at the bottom of FIG. 3 there is shown a K_{RRCintResume} key derivation in accordance with example embodiments of the invention. It is noted that this K_{RRCintResume} key derivation is marked “Inventive” in FIG. 3.

Keys for RRC signalling include:
K_{RRCint} is a key derived by ME and gNB from K_{gNB}, which shall only be used for the protection of RRC signalling with a particular integrity algorithm;
K_{RRCenc} is a key derived by ME and gNB from K_{gNB}, which shall only be used for the protection of RRC signalling with a particular encryption algorithm; and
K_{RRCint_resume} is a key derived by ME and gNB from K_{gNB}, which shall only be used during RRC resume from RRC_INACTIVE for the generation of Resume MAC-I with a particular integrity algorithm.

Advantages of operations in accordance with example embodiments of the invention include that when applying the proposed solution, the verification of the ResumeMAC-I takes only 2 F1-messages (2 messages between CU-DU2) rather than 4 (2 messages between CU-DU2+2 messages between CU and DU1), thus reduces signalling overhead and latency for the resume procedure.

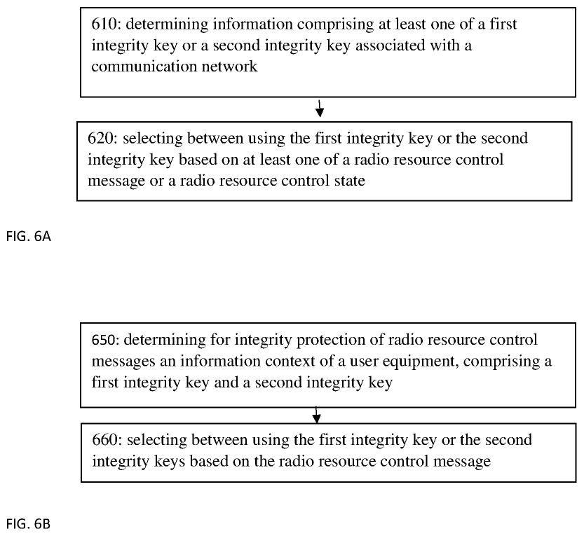

FIG. 6A and FIG. 6B each show a method in accordance with example embodiments of the invention which may be performed by an apparatus.

FIG. 6A illustrates operations which may be performed by a device such as, but not limited to, a user equipment device (e.g., the UE 10 as in FIG. 5). As shown in step 610 of FIG. 6A there is determining information comprising at least one of a first integrity key or a second integrity key associated with the communication network. Then as shown in step 620 of FIG. 6A there is selecting between using the first integrity key or the second integrity key based on at least one of a radio resource control message or a radio resource control state.

In accordance with the example embodiments as described in the paragraph above, wherein there is selecting the second integrity key for at least a radio resource control resume request message, and use the selected integrity key to generate an integrity token for at least the radio resource control resume request message.

In accordance with the example embodiments as described in the paragraph above, wherein there is selecting the second integrity key for at least a radio resource control release message, and use the selected integrity key to generate an integrity token to verify the integrity token validity of the radio resource control release message received from the network.

In accordance with the example embodiments as described in the paragraph above, wherein the determined at least one of the first integrity key or the second integrity key is based upon being released out of a connected state.

In accordance with the example embodiments as described in the paragraph above, wherein the at least one of a first integrity key is generated by a centralized unit associated with the communication network or a second integrity key is generated by a first distributed unit associated with the communication network.

In accordance with the example embodiments as described in the paragraph above, wherein the first integrity key and the second integrity key are determined, by a first distributed unit and centralized unit associated with the apparatus, one of before or after identifying that a radio resource control configuration with the user equipment is to be released and the user equipment is to be dispatched to a radio resource control inactive state.

In accordance with the example embodiments as described in the paragraphs above, wherein generating the second integrity key is based on keying material received from the network.

In accordance with the example embodiments as described in the paragraphs above, wherein the keying material is received upon the user equipment being dispatched to a radio resource control inactive state.

In accordance with the example embodiments as described in the paragraphs above, wherein the keying material is received together with a user equipment identifier to be used in a radio resource control inactive state.

In accordance with the example embodiments as described in the paragraphs above, wherein the at least the first integrity key and the second integrity key is one of predetermined by the user equipment or derived by the user equipment.

In accordance with the example embodiments as described in the paragraphs above, wherein the keying material comprises at least one of an indication of an integrity protection algorithm and an indication of an algorithm identifier.

In accordance with the example embodiments as described in the paragraphs above, wherein the integrity token comprises a resumeMAC-I.

In accordance with the example embodiments as described in the paragraphs above, wherein the first integrity key is the KRRCint key, and the user equipment is using the first integrity key to apply integrity protection for all radio resource control messages but radio resource control resume request message.

In accordance with the example embodiments as described in the paragraphs above, wherein the selected integrity key comprises the second integrity key.

In accordance with the example embodiments as described in the paragraphs above, wherein the keying material comprises an integrity protection algorithm and algorithm identifier which can be fed in to a key derivation algorithm by the user equipment to generate the integrity token for the radio resource control resume request message by the user equipment.

In accordance with the example embodiments as described in the paragraphs above, wherein the information context comprises a security context including a KRRCint_resume key for the user equipment.

In accordance with the example embodiments as described in the paragraphs above, wherein the KRRCint_resume key is used to verify the resumeMAC-I validity as the user equipment performs a radio resource control resume procedure.

In accordance with the example embodiments as described in the paragraphs above, wherein there is storing the information comprising the at least one of a first integrity key or a second integrity key, and wherein the storing is based on a validity timer, wherein at expiration of the validity timer the information context is discarded.

In accordance with the example embodiments as described in the paragraphs above, wherein the validity timer is configured by the first distributed unit as a T_INACTIVE_DU.

In accordance with the example embodiments as described in the paragraphs above, wherein the user equipment has not yet determined it has moved to an area of a communication network controlled by the apparatus.

In accordance with the example embodiments as described in the paragraphs above, there is using the selected integrity key to generate an integrity token for at least a radio resource control resume request message.

A non-transitory computer-readable medium (MEM 10B as in FIG. 5) storing program code (PROG 10C as in FIG. 5), the program code executed by at least one processor (DP 10A as in FIG. 5) to perform the operations as at least described in the paragraphs above.

In accordance with an example embodiment of the invention as described above there is an apparatus comprising: means for determining (TRANS 10D; MEM 10B, PROG 10C, and DP 10A as in FIG. 5) at least one of a first integrity key associated with a communication network or a second integrity key associated with the communication network; then means for selecting (TRANS 10D; MEM 10B, PROG 10C, and DP 10A as in FIG. 5) between using the first integrity key or the second integrity key based on at least one of a radio resource control message or a radio resource control state.

In the example aspect of the invention according to the paragraph above, wherein at least the means for determining, and selecting comprises a non-transitory computer readable medium [MEM 10B as in FIG. 5] encoded with a computer program [PROG 10C as in FIG. 5] executable by at least one processor [DP 10A as in FIG. 5].

FIG. 6B illustrates operations which may be performed by a network device such as, but not limited to, a network node NN 12 and/or NN 13 as in FIG. 5. As shown in step 650 of FIG. 6B there is determining for integrity protection of radio resource control messages an information context of a user equipment, comprising a first integrity key and a second integrity key associated with the apparatus. As shown in step 660 of FIG. 6B there is selecting between using the first integrity key or the second integrity keys based on the radio resource control message.

In accordance with the example embodiments as described in the paragraph above, wherein the first integrity key and the second integrity key are determined, by a first distributed unit and centralized unit associated with the apparatus, one of before or after identifying that a radio resource control configuration with the user equipment is to be released and the user equipment is to be dispatched to a radio resource control inactive state.

In accordance with the example embodiments as described in the paragraph above, wherein there is selecting the second integrity key for at least a radio resource control resume request message, and use the selected integrity key to generate an integrity token for at least the radio resource control resume request message.

In accordance with the example embodiments as described in the paragraph above, wherein there is selecting the second integrity key for at least a radio resource control release message, and use the selected integrity key to generate an integrity token to verify the integrity token validity of the radio resource control release message received from the network.

In accordance with the example embodiments as described in the paragraph above, wherein the determined at least one of the first integrity key or the second integrity key is based upon being released out of a connected state.

In accordance with the example embodiments as described in the paragraph above, wherein the at least one of a first integrity key is generated by a centralized unit associated with the communication network or a second integrity key is generated by a first distributed unit associated with the communication network.

In accordance with the example embodiments as described in the paragraphs above, wherein generating the second integrity key is based on keying material received from the network.

In accordance with the example embodiments as described in the paragraphs above, wherein the keying material is received upon the user equipment being dispatched to a radio resource control inactive state.

In accordance with the example embodiments as described in the paragraphs above, wherein the keying material is received together with a user equipment identifier to be used in a radio resource control inactive state.

In accordance with the example embodiments as described in the paragraphs above, wherein the at least the first integrity key and the second integrity key is one of predetermined by the user equipment or derived by the user equipment.

In accordance with the example embodiments as described in the paragraphs above, wherein the keying material comprises at least one of an indication of an integrity protection algorithm and an indication of an algorithm identifier.

In accordance with the example embodiments as described in the paragraphs above, wherein the integrity token comprises a resumeMAC-I.

In accordance with the example embodiments as described in the paragraphs above, wherein the first integrity key is the KRRCint key, and the user equipment is using the first integrity key to apply integrity protection for all radio resource control messages but at least one of a radio resource control resume request message or a radio resource control release message.

In accordance with the example embodiments as described in the paragraphs above, wherein the selected integrity key comprises the second integrity key.

In accordance with the example embodiments as described in the paragraphs above, wherein the keying material comprises an integrity protection algorithm and algorithm identifier which can be fed in to a key derivation algorithm by the user equipment to generate the integrity token for the radio resource control resume request message by the user equipment.

In accordance with the example embodiments as described in the paragraphs above, wherein the information context comprises a security context including a KRRCint_resume key for the user equipment.

In accordance with the example embodiments as described in the paragraphs above, wherein the KRRCint_resume key is used to verify the resumeMAC-I validity as the user equipment performs a radio resource control resume procedure.

In accordance with the example embodiments as described in the paragraphs above, wherein there is store the information comprising the at least one of a first integrity key or a second integrity key, and wherein the storing is based on a validity timer, wherein at expiration of the validity timer the information context is discarded.

In accordance with the example embodiments as described in the paragraphs above, wherein the validity timer is configured by the first distributed unit as a T_INACTIVE_DU.

In accordance with the example embodiments as described in the paragraphs above, wherein the user equipment has not yet determined it has moved to an area of a communication network controlled by the apparatus.

In accordance with the example embodiments as described in the paragraphs above, comprising: receiving from the user equipment, by a second distributed unit of the apparatus, a user equipment context retrieve request and a radio resource control resume request, wherein the radio resource control resume request comprises the resumeMAC-I and an indication of the integrity token.

In accordance with the example embodiments as described in the paragraphs above, wherein based on the second distributed unit not identifying the user equipment, there is sending towards the centralized unit the radio resource control resume request including a resumeMAC-I.

In accordance with the example embodiments as described in the paragraphs above, wherein based on the second distributed unit identifying the user equipment, there is validating the received resumeMAC-I using the stored key received from the centralized unit.

In accordance with the example embodiments as described in the paragraphs above, wherein there is delivering with the centralized unit the information context to the second distributed unit in response to the requests from the user equipment.

In accordance with the example embodiments as described in the paragraphs above, there is using the selected integrity key to generate an integrity token for at least a radio resource control resume request message.

A non-transitory computer-readable medium (MEM 12B and/or MEM 13B as in FIG. 5) storing program code (PROG 12C and/or PROG 13C as in FIG. 5), the program code executed by at least one processor (DP 12A and/or DP 13A as in FIG. 5) to perform the operations as at least described in the paragraphs above.

In accordance with an example embodiment of the invention as described above there is an apparatus comprising: means for means for determining (TRANS 12D and/or TRANS 13D; MEM 12B and/or MEM 13B, PROG 12C and/or PROG 13C, and DP 12A and/or DP 13A as in FIG. 5) for integrity protection of radio resource control messages an information context of a user equipment, comprising a first integrity key; and a second integrity key associated with the apparatus, and means for selecting (TRANS 12D and/or TRANS 13D; MEM 12B and/or MEM 13B, PROG 12C and/or PROG 13C, and DP 12A and/or DP 13A as in FIG. 5) between using the first integrity key or the second integrity keys based on the radio resource control message.

In the example aspect of the invention according to the paragraph above, wherein at least the means for storing and selecting comprises a non-transitory computer readable medium [MEM 12B and/or MEM 13B as in FIG. 5] encoded with a computer program [PROG 12C and/or PROG 13C as in FIG. 5] executable by at least one processor [DP 12A and/or DP 13A as in FIG. 5].

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of example embodiments of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1-74. (canceled)

75. An apparatus comprising:
at least one processor; and
at least one non-transitory memory including computer program code, where the at least one non-transitory memory and the computer program code are configured, with the at least one processor, to cause the apparatus to at least:
determine information comprising at least one of a first integrity key or a second integrity key associated with a communication network; and
select between using the first integrity key or the second integrity key based on at least one of a radio resource control message or a radio resource control state.

76. The apparatus of claim 75, wherein the at least one non-transitory memory and the computer program code are configured with the at least one processor to cause the apparatus to:
select the second integrity key for at least a radio resource control resume request message, and use the selected integrity key to generate an integrity token for at least the radio resource control resume request message.

77. The apparatus of claim 75, wherein the at least one non-transitory memory and the computer program code are configured with the at least one processor to cause the apparatus to: select the second integrity key for at least a radio resource control release message, and use the selected integrity key to generate an integrity token to verify the integrity token validity of the radio resource control release message received from the network.

78. The apparatus of claim 75, wherein the determined at least one of the first integrity key or the second integrity key is based upon being released out of a connected state.

79. The apparatus of claim 75, wherein the at least one of a first integrity key or a second integrity key is generated by at least one of a first distributed unit or a centralized unit associated with the communication network.

80. The apparatus of claim 75, wherein generating the second integrity key is based on keying material received from the network.

81. The apparatus of claim 80, wherein the keying material is received upon the user equipment being dispatched to the radio resource control inactive state.

82. The apparatus of claim 80, wherein the keying material is received together with a user equipment identifier to be used in the radio resource control inactive state.

83. The apparatus of claim 75, wherein the at least the first integrity key and the second integrity key is one of predetermined by the user equipment or derived by the user equipment.

84. The apparatus of claim 80, wherein the keying material comprises at least one of an indication of an integrity protection algorithm and an indication of an algorithm identifier.

85. The apparatus of claim 76, wherein the integrity token comprises a resumeMAC-I.

86. The apparatus of claim 75, wherein the first integrity key is the KRRCint key, and the user equipment is using the first integrity key to apply integrity protection for all radio resource control messages but at least one of a radio resource control resume request message or a radio resource control release message.

87. The apparatus of claim 75, wherein the selected integrity key comprises the second integrity key.

88. The apparatus of claim 75, wherein the keying material comprises an integrity protection algorithm and algorithm identifier which can be fed in to a key derivation algorithm by the user equipment to generate the integrity token for the radio resource control resume request message by the user equipment.

89. The apparatus of claim 75, wherein the information comprises a security context including a KRRCint_resume key for the user equipment.

90. The apparatus of claim 89, wherein the KRRCint_resume key is used to verify the MAC-I validity when the user equipment receives a radio resource control release message from the network.

91. The apparatus of claim 75, wherein the the at least one non-transitory memory and the computer program code are configured with the at least one processor to cause the apparatus to: store the information comprising the at least one of a first integrity key or a second integrity key, and wherein the storing is based on a validity timer, wherein at expiration of the validity timer the information context is discarded.

92. A method, comprising:
determining at least one of a first integrity key or a second integrity key associated with the communication network; and
selecting between using the first integrity key or the second integrity key based on at least one of a radio resource control message or a radio resource control state.

93. The method of claim 92, where the at least one non-transitory memory and the computer program code are configured with the at least one processor to cause the apparatus to:
select the second integrity key for at least a radio resource control resume request message, and use the selected integrity key to generate an integrity token for at least the radio resource control resume request message.

94. The method of claim 92, comprising:
selecting the second integrity key for at least a radio resource control release message, and using the selected integrity key to generate an integrity token to verify the integrity token validity of the radio resource control release message received from the network.

95. An apparatus comprising:
at least one processor; and
at least one non-transitory memory including computer program code, where the at least one non-transitory memory and the computer program code are configured, with the at least one processor, to cause the apparatus to at least:
determine for integrity protection of radio resource control messages an information context of a user equipment, comprising a first integrity key and a second integrity key associated with the apparatus, and
select between using the first integrity key or the second integrity keys based on the radio resource control message.

96. The apparatus of claim 95, wherein the information context comprising the first integrity key and the second integrity key is determined one of before or after identifying that a radio resource control configuration with the user equipment is to be released and the user equipment is to be dispatched to a radio resource control inactive state.

97. A method, comprising:
determining for integrity protection of radio resource control messages an information context of a user equipment, information comprising a first integrity key and a second integrity key associated with the apparatus, and
selecting between using the first integrity key or the second integrity keys based on the radio resource control message.

98. The method of claim 97, wherein the first integrity key and the second integrity key are determined one of before or after identifying that a radio resource control configuration with the user equipment is to be released and the user equipment is to be dispatched to a radio resource control inactive state.
